(19) United States
(12) Patent Application Publication
(10) Pub. No.: US 2018/0071171 A1
(43) Pub. Date: Mar. 15, 2018

(54) MEDICATION DISPENSING SYSTEM

(71) Applicant: PROTOMED LIMITED, Burnopfield (GB)

(72) Inventor: Norman Niven, Congleton (GB)

(21) Appl. No.: 15/817,927

(22) Filed: Nov. 20, 2017

Related U.S. Application Data
(63) Continuation of application No. 14/868,593, filed on Sep. 29, 2015.
Application No. 14/868,593 is a continuation of application No. 13/511,230, filed on May 22, 2012, now abandoned.

(30) Foreign Application Priority Data
Nov. 27, 2009 (GB) 0920742.4

(51) Int. Cl. A61J 7/04

(52) U.S. Cl. CPC A61J 7/0436; A61J 1/035; A61J 2200/30

(57) ABSTRACT

The present invention relates to a medication tray comprising a plurality a sealed vessels comprising one or more doses of a medicament; a plurality of individually spaced compartments that are adapted to receive the individually sealed vessels; means for releasably retaining said sealed vessels within said compartments. The tray further comprises a detection means adapted to detect and monitor when individual vessel are dispensed from the compartments of the tray.

### FIELD OF THE INVENTION

This invention relates to a medication dispensing system comprising a tray having a plurality of compartments in which one or more individual doses of a medicament are provided in individually sealed vessels positioned in the compartments. More specifically, the present invention provides a medication dispensing system which is configured to detect and/or monitor when the medicament present in a particular vessel/compartment has been dispensed from the tray.

### BACKGROUND

There is a particular need for individual patient medication dispensing systems that can accommodate individual doses of medicament in either solid dosage forms (including, for example, tablets, capsules, pessaries, creams and ointments) or in liquid dosage form (including, for example, solutions, suspensions and emulsions).

International Patent Publication Number WO 2009/047560 (Protomed Limited) describes an individual patient medication dispensing system that can conveniently accommodate different physical forms of medication, including liquid dosage forms as well as creams and ointments. The medication dispensing system described in WO 2009/047560 consists of a medication tray having a plurality of individually spaced compartments, each of which comprises an individually sealed vessel releasably retained therein. The medicament is present within individually sealed vessels and a patent or carer can simply release the required sealed vessel from the medicament tray at the appropriate time and then open the sealed vessel to access the medicament contained therein.

The medication dispensing system described in International Patent Publication Number WO 2009/047560 provides a number of advantages. Firstly, the system improves patient compliance by providing an individual patient medication pack that enables a patient or carer to access the medicament provided in the individually sealed vessels at the appropriate time and on the appropriate day. Secondly, the medicament tray is easy to use because, as previously stated, a patient or carer can simply remove the appropriate sealed vessel from the compartment of the tray and then break the seal on the vessel to access the required dose of medication present in the vessel. Thirdly, the provision of individually sealed vessels located within the individual compartments of the tray enables liquid medicaments as well as metered quantities of creams and ointments to be stored in the tray, in addition to conventional solid dosage forms. The ability to store these different dosage forms in an individual patient medication tray makes these medication dispensing systems extremely versatile.

Conventionally, liquid medication is either provided in bottles or individual sachets or blisters. The use of bottles from which individual doses are measured and dispensed is most common. The use of bottle has a number of drawbacks. Firstly, spillage of medicine can easily occur and the accuracy of the dose administered using medicine measures or spoons can also be an issue. Furthermore, over prolonged periods of time, and with repeated use, the liquid medicine in the present in the container can start to degrade and/or may become contaminated. Therefore, the ability to provide accurate individual dosages of a liquid medicament in an individually sealed vessel provided in a medication tray (in which individual compartments can be labelled to indicate the day/time at which the medication should be taken) assists in enabling the appropriate dose of liquid medication to be taken by the patient, or administered by a carer, at the appropriate time.

These medication systems also enable different dosages of one or more medicaments to be given at different times of the day, or on different days, by simply varying the dosages present in the individual vessels. This enables more complicated dosage regimens to be accommodated, which can be particularly valuable in, for example, clinical trial settings.

Despite the numerous advantages associated with the medication dispensing systems described in WO 2009/047560, and the improved patient compliance that they offer, there still remains a need for further improved medication dispensing systems that can further enhance patient compliance and/or which enable an individual patients' therapy to be monitored more closely.

Thus, it is an object of the present invention to provide a medication system that is configured to monitor the compliance of the patient with their prescribed therapy.

It is a further object of the invention to provide a medication dispensing system in which a means of monitoring patient compliance can be easily added to a medicament tray by the pharmacist at the point of dispensing.

### SUMMARY OF THE INVENTION

The present invention provides, in a first aspect, a medication tray comprising:
a plurality of sealed vessels comprising one or more doses of a medicament;
a plurality of individually spaced compartments that are adapted to receive the individually sealed vessels; and
means for releasably retaining said sealed vessels within said compartments,
characterized in that the medicament tray further comprises a detection means adapted to detect and monitor when individual vessel are dispensed from the compartments of the tray.

In a further aspect the present invention provides a detection means configured to be attached to a medication tray comprising:
a plurality of sealed vessels comprising one or more doses of a medicament;
a plurality of individually spaced compartments that are adapted to receive the individually sealed vessels; and
means for releasably retaining said sealed vessels within said compartments,
characterized in that the detection means is adapted to monitor and detect when an individual sealed vessel is dispensed from a compartment of the tray.

The detection means enables the data about the dispensing of the individually sealed vessels comprising the medicament from the compartments of the tray to be collected, recorded and analyzed. This enables the compliance of the patient with a particular therapeutic regime to be monitored and recorded.

In preferred embodiments, the detection means of the present invention is also relatively inexpensive, so it can be added to a medicament tray as defined herein at a relatively low cost. Furthermore, the detection means can be added, if desired, at the point of dispensing the medication, for example in a pharmacy.

In a further aspect, the present invention provides a method of monitoring patient compliance, said method comprising providing an individual patients' medication in a medicament tray as defined herein and monitoring and/or analyzing the data collected by the detection means.

### DETAILED DESCRIPTION OF THE INVENTION

As previously stated, in one aspect the present invention provides a medication tray comprising:
a plurality of sealed vessels comprising one or more doses of a medicament;
a plurality of individually spaced compartments that are adapted to receive the individually sealed vessels; and
means for releasably retaining said sealed vessels within said compartments,
characterized in that the medicament tray further comprises a detection means adapted to detect and monitor when individual vessel are dispensed from the compartments of the tray.

The present invention also provides a detection means configured to be attached to a medication tray comprising:
a plurality of sealed vessels comprising one or more doses of a medicament;
a plurality of individually spaced compartments that are adapted to receive the individually sealed vessels; and
means for releasably retaining said sealed vessels within said compartments,
characterized in that the detection means is adapted to monitor and detect when an individual sealed vessel is dispensed from a compartment of the tray.

The detection means enables the dispensing of the individually sealed vessels comprising the medicament from the compartments of the tray to be monitored.

As previously stated, the provision of individually sealed vessels enables liquid dosage forms, creams, ointments and conventional solid dosage forms of medicament to be contained within the tray.

Suitably, the medication tray is a medication tray/container such as that described and defined in WO 2009/047560, the entire contents of which are incorporated herein by reference. Suitably, the tray comprises a sealing arrangement as defined in WO 2009/125364, the entire contents of which are incorporated herein by reference. The tray may be formed using a sealing apparatus such as that described in WO 2010/001152, the entire contents of which are incorporated herein by reference.

In an embodiment of the invention, the tray may be a support member which comprises a number of holes in which separate compartments are positioned and retained.

In a preferred embodiment, the individual compartments are preformed integrally with the tray (e.g. moulded integrally as party of the tray structure).

The tray may be formed from any suitable material known in the art. In an embodiment of the invention, the tray is moulded from plastic.

The individually sealed vessels suitably comprise an opening which is provided with a sealed closure or sealing means which is configured to releasably retain the medicament in the vessel. The sealed closure or sealing means can be removed and/or broken in order to access the medicament present in the vessel.

The sealed closure or sealing means which releasably retains the medicament in the vessels may suitably take the form of a sheet of material (suitably flexible material) that covers the opening of the vessel and forms a sealed contact around the opening.

The sheet of material may optionally display printed matter that identifies the medicament present in the vessel.

The sheet of material may display printed matter identifying the medicament present in the vessel and the purpose for, or manner in which, the medicament is to be used.

The sheet of material forming the sealed closure or sealing means may comprise a portion or outer edge which is not directly adhered to the vessel and which can be held and used to peel the sheet of material away from the opening of the vessel, thereby breaking the seal and enabling the medicament present in the vessel to be accessed.

In some embodiments, a peripheral flange may be provided around the top of each vessel, a part of which is readily deformable to assist in peeling off the sheet of material to open the vessel.

Suitably the sheet of material forming the sealed closure or sealing means is a plastic sheet, in particular a transparent plastic sheet. The transparency enables the content of each vessel to visualized.

The vessels are suitably individual pots.

The vessels and the compartments of the tray are suitably of complementary shape and size, such that the vessels can be received within the compartments.

In an embodiment, each compartment may have an aperture in a base region thereof to enable a sealed vessel releasably retained therein to be pushed out of its compartment.

In an alternative embodiment, the compartments comprise deformable sides and/or a deformable base so as to enable pressure to be applied to the compartment, e.g. to the base of the compartment, in order to cause the vessel to be dislodged from the compartment.

The above defined vessels are also described in WO 2009/047560, the contents of which are incorporated herein by reference.

Any suitable means to releasably retain the vessels in the compartments of the tray may be used in the present invention.

In an embodiment, a cover is placed over the troy to releasably retain the vessels within each compartment within the tray. Suitably a vessel present in a compartment of the tray is sealed therein by the cover.

In an embodiment, the cover comprises one or more slidably mounted closure members which can slide to selectively open and expose one or more vessels present in one or more compartments of the tray and thereby enable said vessels to be removed from the tray.

In a further embodiment, the means for releasably retaining the substance in the compartment of the tray is a sheet of material (suitably flexible material) which extends over the openings of the compartments to provide a cover which releasably retains the vessels in the compartments. The contents of any particular compartment can be released by selectively removing or breaking the portions of the sheet. The sheet may comprise perforation positioned at or around the opening of each compartment to facilitate the breaking of the sheet so as to enable the vessels present in the compartments to be dispensed.

Alternatively, the portions of the sheet (suitably portions defined by perforations around the opening of each compartment), may be broken to release the vessel present in the compartment by applying a pressure to the base and/or sides of the compartment to eject the vessel through the sheet.

Suitably, the sheet that releasably retains the vessels within compartments of the tray is a plastic sheet, suitably a transparent plastic sheet, which may optionally comprises some text printed thereon to identify the content of each compartment and/or provide directions to the user.

In a preferred embodiment, a single sheet of material is applied to the upper surface of the medicament tray to provide the sealed closure or sealing means that releasably retains the medicament in the vessels, and the means for releasably retaining the vessels in the compartments of the tray. In such cases, the open vessels may be positioned within the compartments of the tray and the appropriate medication is then placed in each vessel as appropriate. A single sheet of material (typically plastic material) is placed over the upper surface of the tray. The sheet is then sealed around the opening of each vessel to form the individually sealed vessels and perforated portions of the sheet extend around each compartment provide the means by which the sealed vessel is releasably retained in the compartment of the tray. During use, an upward pressure is applied to the desired compartment and this causes the perforated portion of the sheet associated with that compartment to break away at the perforations and thereby enable the sealed vessel to be removed from the compartment of the tray. The removed portion of the sheet still provides the sealed closure for the vessel and this can be peeled off or broken to access the medication present in the vessel.

The detection means serves to detect and/or monitor when a vessel is dispensed from an individual compartment of the tray during use.

Suitably, the detection means comprises sensors associated with each compartment of the tray. Suitably, the detection means further comprises electrical connections which connect each sensor to a power supply and a data storage and/or processing means where data from the sensors can be stored and/or processed.

In an embodiment of the invention, the detection means further comprises a transmission means to enable data stored in the data storage and/or processing means to be transmitted and/or downloaded, optionally for further analysis and processing.

The detection means may further comprise a user interface to enable an operator to input additional data which can be stored on the storage/processing means and optionally correlated with data from the sensors.

The detection means may further comprise a visual display to display information to the user.

Any suitable sensor capable of detecting when the vessel present in any given compartment is released may be used in the container of the present invention.

The sensor may comprise electrical contacts which connect to form an electrically conductive circuit (and thereby generate an electrical signal) when an operator applies a pressure to a particular compartment to dispense the vessel releasably retained therein.

Alternatively, the sensor may comprise an electrically conductive circuit or track which is broken when an operator applies a pressure to release a vessel from a compartment of the tray. The breakage of the circuit can be detected and recorded.

In an embodiment of the invention, the sensor is located in the cover/sheet that releasably retains the vessels in the compartments of the tray and the opening of each individual compartment may comprise an individual electrically conductive track or circuit which is broken when the cover/sheet is broken or removed as the vessel is dispensed.

In a preferred embodiment, the sensor is positioned in the base of tray. The sensors in the base are positioned such that when a pressure is applied to dispense a vessel from a particular compartment, the sensor is activated. In an embodiment, the sensor is an electrically conductive track which is broken when pressure is applied to the base of the compartment, and said breakage of the circuit can be detected and recorded by the data storage and/or processing means.

The data storage/processing means may be any suitable electronic data storage and/or processing device such as, for example, a microchip or module, which can be conveniently incorporated into the medicament tray. Suitable microchips and modules are commercially available and can be programmed with appropriate software to provide the functionality that is required.

The data storage/processing means is preferably configured to receive electrical signals from the sensors associated with each individual compartment. Furthermore, the data storage and/or processing means may be pre-programmed to monitor the response from each sensor over time. For example, when a sensor is activated by an operator dispensing a vessel from a particular compartment, that event can be recorded and coupled with appropriate date/time data.

In addition, the data storage and/or processing means may be pre-programmed to detect whether a particular sensor associated with a particular compartment is activated within a predetermined time frame. This enables the detection means to monitor whether the correct medication is being taken at the appropriate time. In addition, if the medication has not been dispensed at the required time, the detection means can either record the event or, optionally, it may trigger an alert, such as an alarm, flashing light or LED, or a message sent via the transmission means, to draw attention to the missed dose of medication.

The data storage and/or processing means may be further configured to receive manual data inputs from a user interface, where an operator can input additional data by pressing one or more buttons on the user interface. The pressing of a particular button may be correlated with other data from the sensors and stored by the storage/processing means.

The user interlace is suitably provided on a surface of the container or the detection means.

In an embodiment of the invention the detection means comprises a data storage and/or processing means and a user interface to enable data to be input manually. In this embodiment, sensors are not utilized and data can be simply input manually by the patient or carer when a vessel is dispensed from the tray. Preferably, however, the detection means does comprise sensors to automatically detect when a vessel is dispensed from the tray.

The power supply may be a battery which provides a low voltage power supply to the sensors and the storage/processing means.

The transmission means may be any suitable means for transmitting data from the storage/processing means. For example, the transmission means may be a data transfer port that can be connected to an external computer to enable the data from the data storage and/or processing means to be downloaded. Alternatively, the transmission means may be a transmitter which can transmit data wirelessly to a receiver. For example, the tray may be configured to wirelessly connect to the Internet to transmit data on-line. A further alternative is that the data can be accessed by scanning the tray.

Suitably, the transmission means uses RFID, NFC, Bluetooth or WIFI to transmit the data. In a particular embodiment, the transmission means is a short range transmitter that utilizes RFID data transmission.

The data processing means may further comprise an alerting means, such as an alarm or flashing light/LED, which can be activated if, for example, a vessel present in a particular compartment has not been dispensed at the correct time, or if a vessel has been dispensed from a compartment at an incorrect time.

Suitably the data storage/processing means, power supply, and the transmission means may be provided in a single module, such as, for example, the Cypak Electronic Module (CEM083), Cypak AB, Sweden.

In a particular embodiment, the detection means is incorporated into a base that is adapted to be fitted to the bottom of the tray to form a medicament tray of the invention as defined herein.

Suitably the base comprises a plurality of sensors arranged within the base so that they align with the base of each compartment of the tray, and wherein the sensors are adapted to detect when a pressure is applied to dispense a sealed vessel from a compartment of the tray.

As previously indicated, the sensor may be in the form of a switch which is activated when an operator applies a pressure to the base of the container to dispense a vessel from a particular compartment of the tray. Alternatively, the base may comprise portions that are configured to be dislodged (or “break away”) from the remainder of the base when a pressure is applied, each portion being aligned with base of a compartment of the tray and provided with an electrically conductive circuit or track which is broken when said portion of the base is dislodged. Suitably, said portions of the base are surrounded by perforations to facilitate their dislodgement from the remainder of the base.

The base will suitably further comprise the data storage and/or processing means, power supply and transmission means as defined hereinbefore. Suitably, the base also comprises a user interface.

The base may be made from any suitable material that can be deformed by an operator to enable the contents of the individual compartments to be dispensed.

In a particular embodiment, the base may be made from cardboard. Suitably the base comprises two sheets of cardboard and sandwiched between the sheets of cardboard are printed electrically conductive tracks which connect the sensors to the data storage/processing means and the power supply.

Preferably the base further comprises a means for adhering the base to the bottom of the tray. The upper surface of the base may be provided with an adhesive to adhere the base to the underside of the tray. Alternatively and/or in addition, the base may comprise one or more flanges provided with adhesive which can be folded to adhesively engage the sides of the tray and secure the base in position.

The systems of the present invention provide an automated means by which patient compliance can be monitored. Data regarding whether or not medication has been taken at the correct time can be collected and stored on the data storage and/or processing means. These data can be monitored periodically, for example at the end of a particular period of treatment covered by the medication system, or at intervals during the treatment period. In a particular embodiment, data can be monitored in real time, if desired.

The individual that can access the data could be a pharmacist, doctor, nurse, a carer, or the patient.

The detection means may be further configured to store data about the identity of the person accessing the data and the date/time that the data was accessed. This enables the detection means to also record how often the patient is being monitored.

In a particular scenario, the patient or carer could return the container to a doctors surgery or a pharmacy at the end of the treatment period and the data stored in the storage/processing means can be downloaded and the compliance of the patient with the prescribed therapy can be assessed.

In a further scenario, a health visitor, such as doctor or nurse, can access the information from the tray when they visit the patient.

In a yet another scenario, the data can be accessed remotely, for example via the internet, to enable remote monitoring of patient compliance. In yet another alternative, data can be sent to a mobile device, such as, for example, a mobile phone.

The data storage and/or processing means can also be programmed to perform additional functions, such as, for example:
detecting when medication has not been taken and raising an alarm;
detecting when too much medication has been accessed, e.g. the medicament from a number of compartments of the tray is dispensed and there is the potential danger of over dose;
correlating the dispensing of a medicament from the tray with other medical interventions or assessments, such as issuing alerts to take a blood pressure reading, blood sample etc.
re-ordering a patients' medication automatically by transmitting a message when the medication present in the tray has run out or is getting close to running out.

A key advantage associated with the provision of a separate detection means is that can be fitted to a tray at the point of dispensing. The pharmacist can then decide whether the detection means is required with the medicament tray for any given patient.

According to a further aspect of the invention, there is provided a system comprising a medication tray as defined herein in combination with a computer for storing data and a printer for printing an information sheet displaying information relating to the medicaments packaged in the tray and a device adapted to automatically apply a printed sheet to the medicament tray to releasably retain the vessels within the compartments.

The system may also include software to display on a computer screen an image of a container as aforesaid and to enable an image representative of a substance to be packaged to be displayed on or adjacent an image of an individual vessel within the container.

The software may display the substance by drag and drop from a list of substances in text form displayed alongside the container image on the screen.

The software may be adapted to convert the display of an image of the substance on the screen into text to be printed on the sheet.

The software may be adapted to produce an image on the screen of a set of data representative of the intended use of the substances to be packaged, such as a date by which a packaged substance should be used.

The system may include an outer container for transportation, adapted to receive a plurality of the aforesaid containers in superimposed relationship with spaced dividing members whereby the aforesaid containers may be housed within the outer container in the manner of drawers.

### PORTABLE MEDICAMENT CARRIERS

While the system described above provides a convenient means of monitoring the dispensing medication from a medicament tray, there may be occasions when a more portable medication system is required.

The present invention therefore provides a temporary storage and/or medication carrier configured to receive a number of sealed vessels from a medicament tray and releasably retain them in a convenient carrier of reduced size relative to the medicament tray.

Thus, according to a further aspect of the present invention, there is provided a medication temporary storage and transporting carrier comprising a tray with a closable lid, the tray defining at least one aperture configured to receive a sealed vessel of complementary lateral dimensions such that the vessel, having an upper edge peripheral flange, rests upon the tray around the aperture with the body of the vessel extending beneath the tray, the lid being closable over the tray to retain the or each vessel therein, wherein the carrier further comprises a detection means configured to record when a vessel is dispensed from the tray.

Closure means may be provided to retain the lid in its closed position thus to retain the or each container on the tray.

The closure means may be a frictional peg and socket arrangement.

The closure means may be a lip and flexible catch arrangement.

In an embodiment, the tray may define four such apertures arranged in a single row thus to carry four such containers side-by-side.

In alternative embodiment, the tray may define four such apertures arranged in pairs thus to carry four such containers in two side-by-side pairs.

The tray and lid may be made as a single piece from moulded plastic.

The tray and lid may be made as a single piece from paperboard.

Suitably the detection means for this portable device comprises data storage/processing means for collecting data and a user interface to enable an operator to input manually input data regarding when the contents of a sealed container have been consumed.

The detection means may further comprise transmission means as defined hereinbefore to enable the data from the temporary storage and transporting carrier.

Embodiments of the invention will be now be described, by way of example only, with reference to the accompanying drawings, in which:

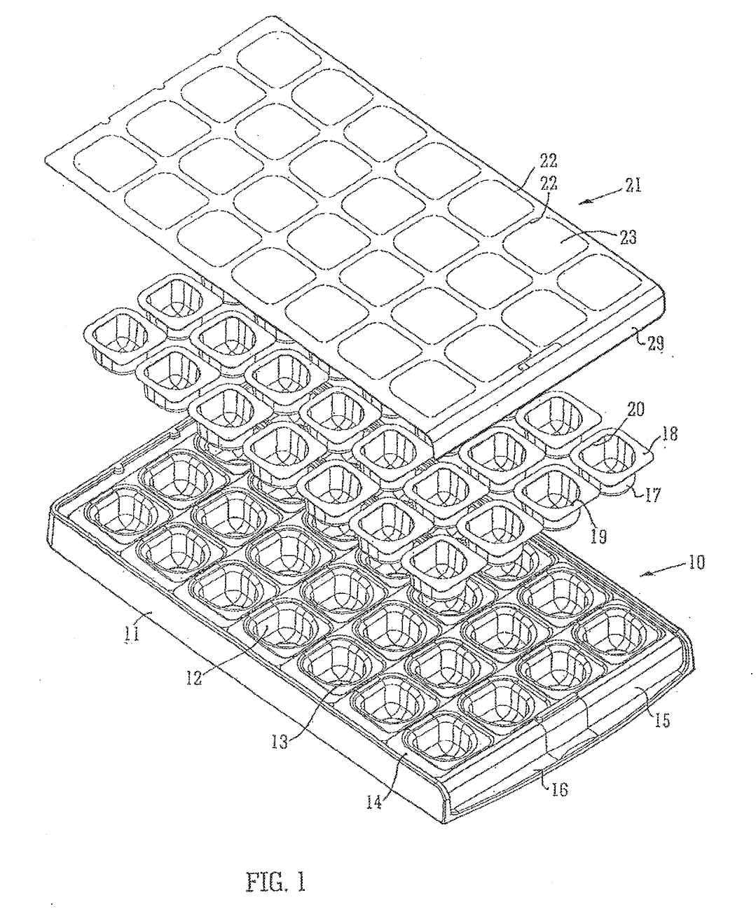

FIG. 1 is an exploded perspective view of a suitable medication container for use with the detection means of the present invention;

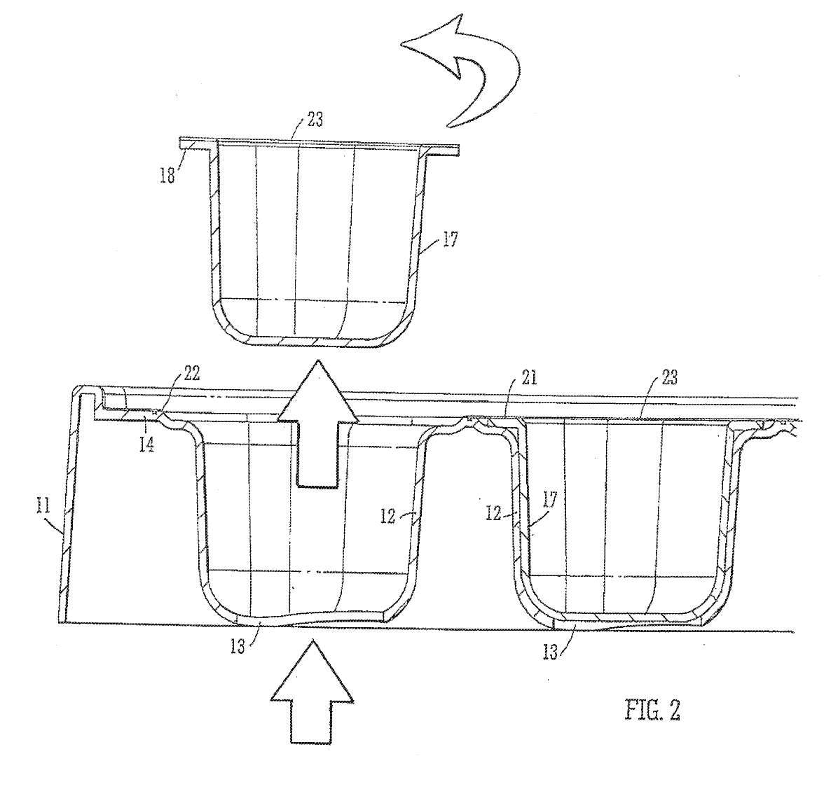

FIG. 2 is an enlarged cross-sectional view of part of the container of FIG. 1;

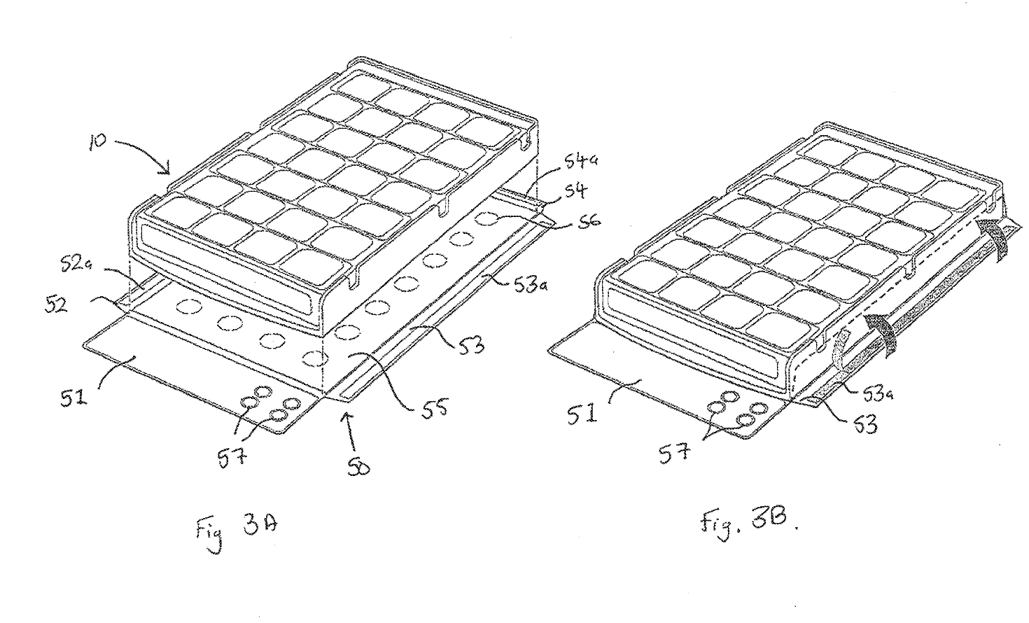

FIG. 3A shows a perspective view of the container of FIG. 1 and a detection means according to the present invention;

FIG. 3B shows a perspective view of the container of FIG. 1 positioned on a detection means according to the present invention;

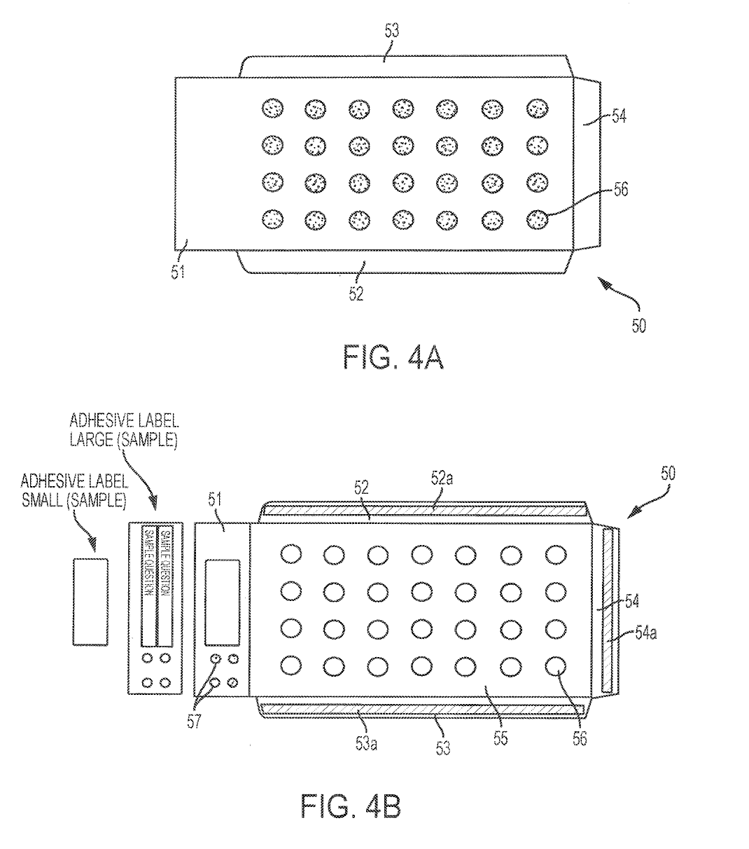

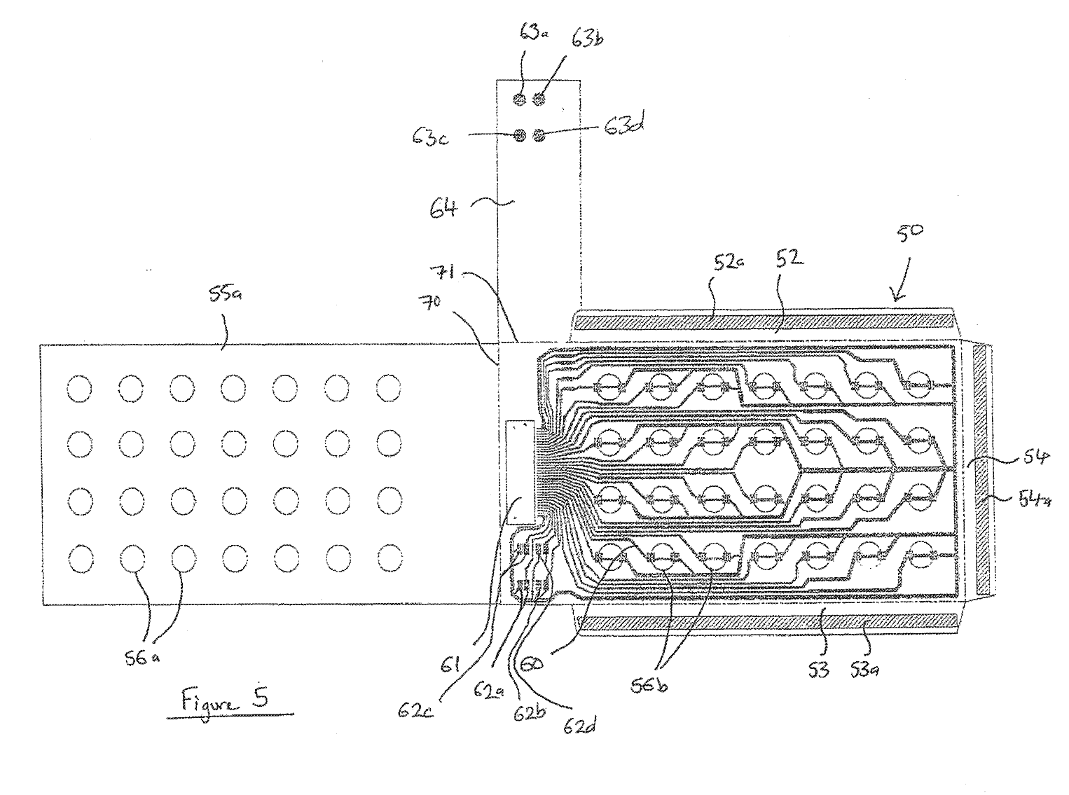

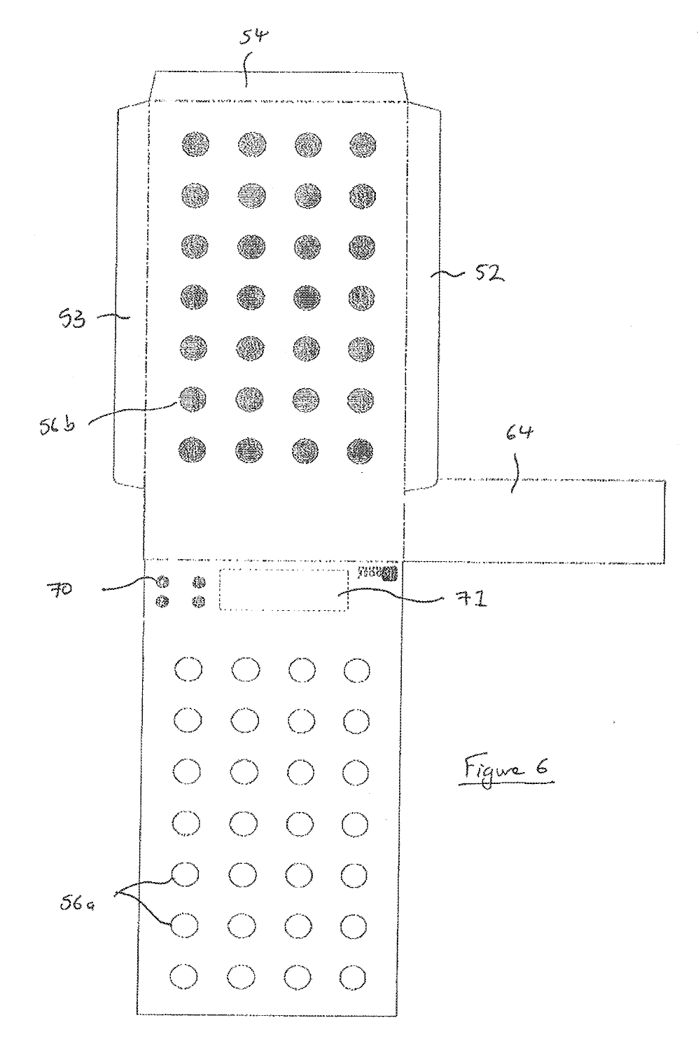

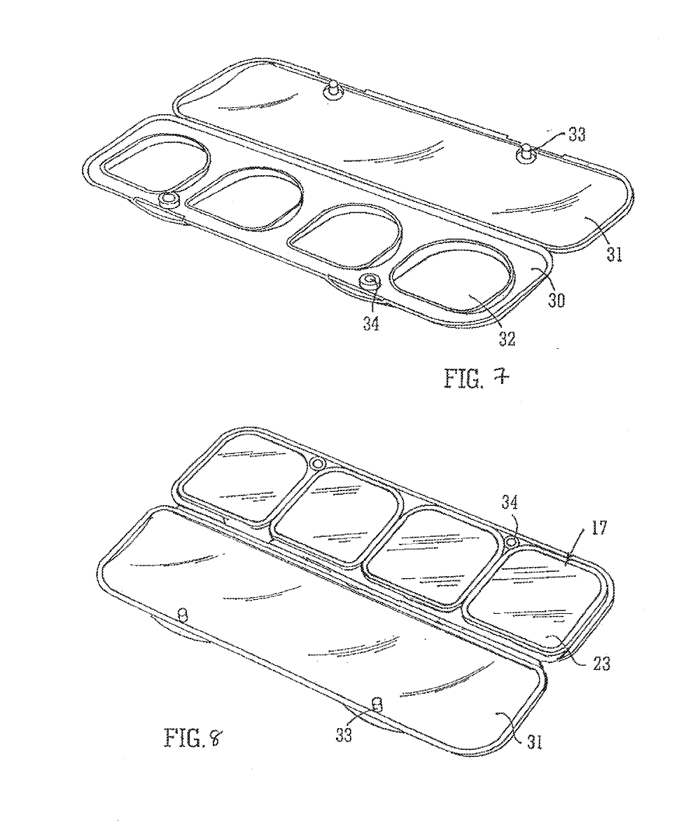

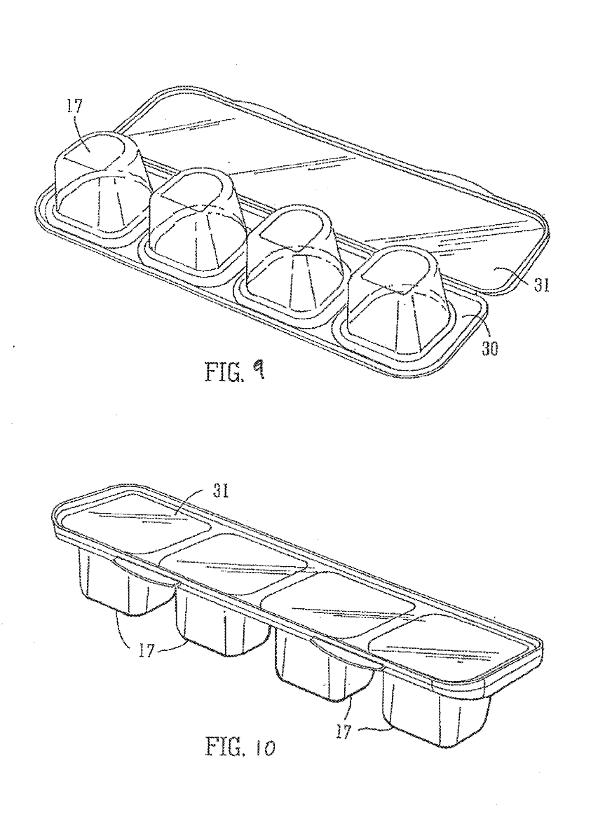

FIG. 4A shows an underside view of the detection means shown in FIGS. 3A and 3B;

FIG. 4B shows a top view of the detection means shown in FIGS. 3A and 3B;

FIG. 5 shows a top view of the detection means shown in FIGS. 3A and 3B in an unassembled form; and

FIG. 6 shows an underside view of the detection means shown in FIGS. 3A and 3B in an unassembled form;

FIG. 7 is a perspective view of a temporary storage and transporting carrier according to the present invention;

FIG. 8 shows the carrier of FIG. 7 with four sealed medication containers therein;

FIG. 9 is a view of the carrier and the containers shown in FIG. 8, from beneath;

FIG. 10 shows the carrier of FIGS. 8 and 9 with a closed lid to retain the containers;

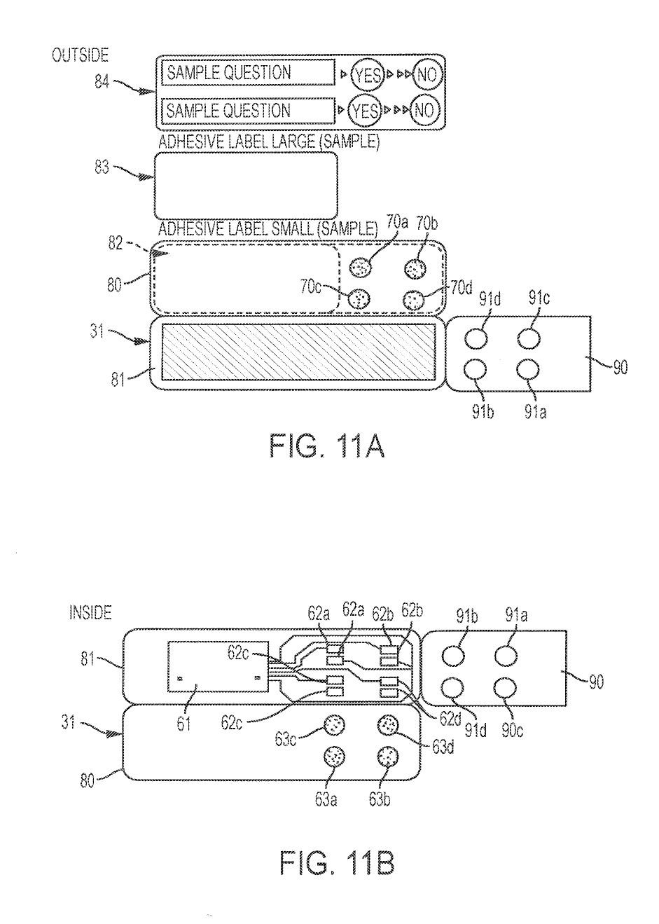

FIG. 11A shows the plan view of the external surface of an unassembled the lid of the carrier according to the present invention; and

FIG. 11B shows the plan view of the internal surface of an unassembled the lid of the carrier according to the present invention.

In the following description of the Figures, like reference numerals are used to denote like or corresponding parts in different figures.

The following description, by way of example, is of a medicament tray for discretely packaging a plurality of quantities of medication in, for example, liquid, tablet, capsule, cream or ointment form according to the invention. Its principal intention is to produce a monitored dosing system for medication where both the patient and the dispensing personnel can be certain that the medication is correctly and safely prepared and taken. Such a system is for the benefit of not only patients and carers but also of pharmacists.

Referring now to FIGS. 1 and 2, a tray generally indicated at 10, of a plastics material and formed to define side walls 11 and an array of individual preformed, side-by-side compartments 12 each having an opening 13 at its base and a common upper platform 14 extending across the tray 10 between the compartments 12. A front wall 15 provides a surface for the display of data concerning the contents of the tray and a lip 16 enables the tray to be withdrawn from an outer container to be described.

Located within each compartment 12 is a vessel in the form of an individual pot 17 for containment of a medicament to be packaged. Each pot 17 has an upper flange 18 which, when the pot is located in the tray, rests upon, and flush with, the platform 14. The pots may be of the same material as the tray 11, and are preferably transparent.

The shape of the recess defined within each pot 17 is such as to have a curved upper rim 19 at least at one side. Opposite the curved rim 19 in each pot is a straight end 20. The wails of each pot also conform to the shape of the upper rim.

For preference, each pot 17 is of such a size as to be an interference fit within its compartment which is of complementary shape and size.

With all of the pots 17 in place a pharmacist may place the appropriate medication in each pot either by using a measured pipette for liquid medication or by placing tablets or capsules into the pots for solid medication.

To complete the container a flexible sheet 21 of a non-permeable material having perforations 22 is placed over the filled tray and sealed, as will be described. The perforations 22 coincide with the outer peripheries of the pots 17, thus to define individual sealed films 23, one across each pot. The sheet 21 is adhesively sealed to the platform 14 and around each individual pot flange 18.

With the sheet in place the pots can be removed individually by pushing a pot upwards through the opening 13 in the associated compartment, thus breaking the perforation in the sheet 21, while maintaining the integrity of the remainder of the sealed film 23. This action is shown in FIG. 2 and it can be seen that once the pot is removed, the sealed film 23 remaining on the flange 18 can be peeled off to open the pot whereupon the medication can be taken. The curved rim 19 of each pot facilitates the taking of liquid medication. The regions of the flange 18 either side of the curved rim will have sufficient flexibility that they can be deformed to assist in the release of the individual sealed film 23.

In this manner, therefore, individual pots can be removed whilst the remainder are retained and sealed on the tray 10. The individual films 23 may be printed, for example, with a time and date and the contents of the associated pot. A front flap 29 of the sheet 21 can be printed with information pertaining to the contents of the entire tray.

To avoid any risk of contamination it is intended that the entire tray 10 be disposable.

FIGS. 3A and 3B illustrate a detection means according to the present invention being fitted to the tray 10 described in reference to FIGS. 1 and 2 to form a medicament tray according to the present invention. The detection means is in the form of a cardboard base 50 which is configured to be fitted to the underside of the tray 10. The base 50 comprises a base portion 55 which receives the underside of the tray 10, as shown in FIG. 3B. The tray 10 is secured in position by adhesive strips 52a, 53a and 54a which are provided on flanges 52, 53 and 54 respectively.

A front flange 51 extends outwards and provides a user interface in the form of manually operable buttons 57. An operator can press these buttons during use to manually input data. For example, the buttons can be pressed to provide a response to certain health or therapy related questions.

The base portion 55 further comprises a number perforated portions (one of which is shown by reference 56). These perforated portions align with the opening 13 in the base of each individual compartment of the tray 10. The significance of these base portions will be described further in relation to FIGS. 5 and 6.

Further views of the cardboard base 50 are shown in FIGS. 4A (underside view) and 4B (top view). A label (such as 58a or 58b) can be applied to the top surface of the flange 51 to provide details about the individual patient, the medication and/or the data that can be input by pressing the buttons 57.

FIG. 5 shows a top view of an un-assembled base 50. The base portion 55 and flange 51 of the base 50 are formed by an upper portion of cardboard 55a and a lower portion 55b, The flange 51 further comprises a flap 64 disposed between the upper portion 55a and the lower portions 55b. The base is assembled by folding the flap 64 over along fold line 71 and then folding the upper portion 55a over onto the lower portion 55b along the fold line 70.

The upper portion 55a comprises 28 perforated portions 56a. These perforated portions align with the 28 corresponding perforated portions 56b on the lower portion 55b when the upper portion 55a is folded over about fold line 70.

A module 61 (Cypak Electronic Module (CEM083) Cypak, Sweden) is also secured on the part of the lower portion 55b that ultimately forms the flange 51 in the assembled base 50. This module forms an integrated power supply, data storage and/or processing means and transmission means. A plurality of electrically conductive ink tracks (such as that shown by reference 60) are printed onto the lower portion 55b. Each of the twenty eight perforated portions 56b is traversed by a separate electrically conductive track which is connected to a separate port of the module 61. The module provides a low level electrical current across each of the 28 perforated portions on the lower portion 56b. During use, an operator wishing to release a pot comprising medication from the tray 10 applies a pressure to the underneath of the perforated portion 56 of the assembled base 50 as shown in FIGS. 3A, 3B, 4A and 4B. This pressure causes the perforated portion 56 to break away/dislodge from the remainder of the base and forces the pot 17 to be released from the compartment of the tray 10. This dislodgement of the perforated portion 56 breaks the printed electrically conductive track associated with the specific portion 56 and the compartment concerned. The breaking of the circuit is detected and recorded by the module 61 and is correlated with the date and time that the medicament in the corresponding pot 17 is dispensed. The data recorded by the module can be downloaded when desired via a RAD transmitter.

A further four ports of the module are connected to four broken circuits (62a-d), which are again formed from electrically conductive ink tracks. The flap 64 comprises four electrical contacts 63a-d printed thereon. Each contact 63a-d is positioned so that it resides above a respective broken junction 62a-d when the flap 64 is folded over about fold line 71. The contacts 63a-d are also aligned with the buttons 57 formed on the upper surface of the flange 51 when the upper portion 55a is folded over about the fold line 70. Thus, during use, the operator can press one of the buttons 57 which forces the corresponding contact 63a-d to contact the ends of the corresponding junction 62 to form a completed circuit through which a current can flow. The flow of a current through the broken junction is detected and recorded by the module 61. The pressing of a button can be correlated with, for example, the answer to a particular question to provide further information about the patient and/or their therapy.

FIG. 6 shows the underside of the unassembled base 50. Referring to FIG. 6, the perforated portions of the base 56b can be coloured so that an operator can easily see where to apply a pressure to dispense the appropriate pot 17 from the tray.

Referring now to FIGS. 7 to 10, if a patient wishes to carry, in a more convenient manner, four such sealed pots, for example when leaving home for the day to visit relatives or friends, there is provided, in accordance with the invention, a temporary storage and transporting carrier comprising a flat tray 30 with a hinged and closable lid 31. The carrier is made from a single piece of moulded plastics.

Four, in-line, side-by-side apertures 32 are provided in the tray 30, each of which, as can be seen, is of complementary shape and size to each of the pots 17 removed from the tray 10 and is therefore of complementary lateral dimensions such that when each pot is inserted into one of the apertures 32 its flange 18 rests upon the tray and is substantially flush with the surface thereof. A frictional peg and socket arrangement 33, 34 is provided to retain the lid in a closed position when required.

FIG. 8 illustrates the carrier with four pots 17 contained thereby with the individual sealed film 23 retaining the contents of the pots.

FIG. 9, which is an underneath view, shows how the body of each pot extends beneath the tray.

FIG. 10 shows the lid 31 in a closed position to retain the four pots in the carrier. Whilst the tray is preferably made as a single piece from moulded plastics, nevertheless it may be made from paperboard so as to be disposable if required.

Although not shown in FIGS. 7 to 10, the temporary storage and transporting carrier of the present invention further comprises a detection means to record information about when the contents of a particular pot 17 is consumed. The detection means is not automatically activated, and instead requires the manual input of information via a user interface.

Plan views of an unassembled lid 31 of the temporary storage and transporting carrier comprising a detection means according to the invention is shown in FIGS. 11A (external surface) and 11B (internal surface). As shown in these figures, the lid 31 comprises a top portion 80 and a lower portion 81. Referring to FIG. 11A, the external surface of the top portion comprises four push buttons 70a-d and a space 82 for a label to be applied. The label may be a small label 83 or a larger label 84 which extends over the buttons 70a-d. The labels may indicate what each button is for or may comprise a number of sample questions which are answered by pressing a particular button. For example, the question could be: “Has the lunchtime medication been taken?” and the appropriate button is pressed to answer this question.

Referring to FIG. 11B, the lower potion of the lid 81 comprises on its internal surface a module 61 (such as the Cypak Electronic Module (CEM083) Cypak, Sweden) and four separate broken printed circuits 62a-d. Printed electrical contacts 63a-d are provided on the internal surface of the upper portion of the lid 80 and are aligned with the push buttons 70a-d respectively. The lid also comprises a flap 90 provided with holes 91a-d. To assemble the lid 31, the flap 90 is folded over onto the internal surface of the lower portion 81 and the upper portion 80 is then folded onto the lower portion so that the flap 90 is disposed between the upper and lower portions and the holes 91a-d are disposed between the contacts 63a-d and the broken circuit junctions 62a-d respectively.

During use, an operator can depress one or more of the buttons such as, for example, 70a and this urges the contact 63a through the hole Ola and into contact with the broken junction 62a to complete the circuit and enable a current to flow which is detected and recorded by the module 61. The module can also store the date and time at which the button was pressed.

Thus, the temporary storage and transporting carrier described in reference to FIGS. 7 through to 11B enable data from the patient to be conveniently collected when a patient is remote from their usual place of residence.

It will be appreciated that a temporary storage and transporting carrier made in accordance with the invention is a convenient accessory for a patient who may wish to carry a smaller number of sealed pots ,as opposed to the entire tray 10 shown in FIG. 1. Whilst carriers having capacity for four pots have been described and illustrated, nevertheless other numbers are envisaged, for example, just two pots may be sufficient for a short period, say for half a day's medication. Alternatively, larger carriers may be appropriate carrying 7 pots.

A temporary storage and transporting carrier for medication, in accordance with the invention, increases the likelihood of correct dosages of medicines to be taken at the correct time, and provides a means for the continued monitoring of the therapy. Once a pot 17 has been removed from the carrier it is disposed of so that patients and carers can readily determine at any time, which doses have been removed. The carriers may be manufactured in different colours thus to allow family members readily to distinguish individual medications without opening. However, the carriers can be manufactured in materials which are largely transparent so that the patient and dosage information printed on the individual films 23 may be read without opening the lid. While the invention has been described and illustrated in relation to the temporary storage and transportation of medication, other substances may be contained within the pots and conveniently transported in a carrier of the invention.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A medication tray comprising:
a plurality of sealed vessels comprising one or more doses of a medicament;
a plurality of individually spaced compartments that are adapted to receive the individually sealed vessels; and
means or releasably retaining said sealed vessels within said compartments;
characterized in that the medicament tray further comprises a detection means adapted to detect and monitor when individual vessel are dispensed from the compartments of the tray.

2. A medication tray according to claim 1, wherein the detection means comprises a sensor associated with each compartment to detect when each individual vessel is dispensed.

3. A medication tray according to claim 2, wherein electrical connections connect each sensor to a power supply and a data storage and/or processing means where data from the sensors is stored and/or processed.

4. A container according to claim 2, wherein detection means further comprises transmission means to enable data stored in the data storage and/or processing means to be transmitted/downloaded.

5. A container according to claim 2, wherein the detection means further comprises a user interface to enable an operator to input additional data which can be stored on the storage/processing means and optionally correlated with data from the sensors.

6. A container according to claim 1, wherein the vessels are individual pots which are released from the compartments of the container by applying a pressure to the base of the compartment.

7. A container according to claim 6, wherein the compartment comprises an opening in its base to enable the vessel to contacted and pushed out of the compartment during use.

8. A container according to claim 1, wherein the detection means is provided as a base that is fitted to the bottom of the container.

9. A container according to claim 8, wherein the base comprises a plurality of sensors arranged within the base so that they align with the base of each compartment of the tray, and wherein the sensors are adapted to detect when a pressure is applied to the base of the compartment of the tray to dispense the vessel located therein.

10. A container according to claim 8, wherein the base further comprises the data storage/processing means, the transmission means and the power supply.

11. A detection means configured to be attached to a medication tray comprising:
a plurality of sealed vessels comprising one or more doses of a medicament;
a plurality of individually spaced compartments that are adapted to receive the individually sealed vessels; and
means for releasably retaining said sealed vessels within said compartments,
characterized in that the detection means is adapted to monitor and detect when an individual sealed vessel is dispensed from a compartment of the tray.

12. A medication temporary storage and transporting carrier comprising a tray with a closable lid, the tray defining at least one aperture configured to receive a sealed vessel of complementary lateral dimensions such that the container, having an upper edge peripheral flange, rests upon the tray around the aperture with the body of the container extending beneath the tray, the lid being closable over the tray to retain the or each container therein, wherein the carrier further comprises a detection means configured to record when a dosage of medication is taken.

13. A method of monitoring patient compliance, said method comprising providing an individual patients' medication in a medicament tray as defined in claim 1 and monitoring and/or analyzing the data collected by the detection means.
